(19) United States
(12) Patent Application Publication
(10) Pub. No.: US 2012/0223888 A1
(43) Pub. Date: Sep. 6, 2012

(54) INFORMATION TRANSMISSION SYSTEM

(75) Inventor: Chih-Feng Chien, Taipei (TW)

(73) Assignee: PRIMAX ELECTRONICS LTD., Taipei (TW)

(21) Appl. No.: 13/086,885

(22) Filed: Apr. 14, 2011

(30) Foreign Application Priority Data
Mar. 4, 2011 (TW) 100107362

(51) Int. Cl. H04B 7/00; G06F 3/033; G06F 3/02

(52) U.S. Cl. 345/168; 345/157; 455/41.2

(57) ABSTRACT

An information transmission system includes a first wireless input device, a first wireless transceiver, and second wireless transceiver. The first wireless transceiver and the second wireless transceiver are mounted on a first host and a second host, respectively. Moreover, a first input information issued from the first wireless input device is received by the first wireless transceiver in every first time interval. Moreover, first transmission information issued from the first wireless transceiver in every second interval is received by the second wireless transceiver, and a second transmission information is issued from the second wireless transceiver in every third time interval. The second transmission information is received by the first wireless transceiver in every third time interval. In such way, information can be exchanged between the first host and the second host.

### FIELD OF THE INVENTION

The present invention relates to an information transmission system, and more particularly to an information transmission system for exchanging information between two computer hosts.

### BACKGROUND OF THE INVENTION

With increasing development of science and technology, the hardware components used in wireless communication technologies have experienced great growth. As known, the applications of the 2.4G proprietary radio frequency technology are widespread.

Generally, a wireless receiver and a computer peripheral input device (e.g. a keyboard, a mouse, or the like) are collaboratively applied to a wireless radio frequency technology. FIG. 1 schematically illustrates an application of a wireless radio frequency technology according to the prior art. Please refer to FIG. 1. A wireless receiver 10 is mounted on a computer host 11. The wireless receiver 10 cooperates with a wireless mouse 12 and a wireless keyboard 13. After a control information is inputted by the user through the wireless mouse 12 or the wireless keyboard 13, the control information will be transmitted from the wireless mouse 12 or the wireless keyboard 13 to the wireless receiver 10 through a corresponding antenna. After the control information is received by the wireless receiver 10 through a corresponding antenna, the control information is inputted into the computer host 11. According to the control information, the user may control the computer host 11 to execute a corresponding function, e.g. the function of controlling the cursor or inputting characters. Conventionally, the control information is received by the wireless receiver 10 in a time-division manner. That is, the wireless receiver 10 is previously set to receive the mouse control information in a mouse time interval and receive the keyboard control information in a keyboard time interval. In the mouse time interval, only the control information issued from the wireless mouse 12 is received by the wireless receiver 10. Whereas, in the keyboard time interval, only he control information issued from the wireless keyboard 13 is received by the wireless receiver 10. In such way, the signal interference problem will be avoided.

Recently, as the hardware components are gradually improved, the speed of receiving and processing signals by the wireless receiver is largely enhanced. Moreover, since the antenna of the conventional wireless receiver 10 is not used for issuing signals, the uses of the hardware components waste resources. Therefore, there is a need of improving the architecture of the wireless receiver and the input device.

For obviating the drawbacks encountered from the prior art, the present invention provides an information transmission system for fully utilizing the hardware resources.

### SUMMARY OF THE INVENTION

The present invention provides an information transmission system for exchanging information between two computer hosts and fully utilizing the hardware resources.

In accordance with an aspect of the present invention, there is provided a wireless radio frequency information transmission system. The wireless radio frequency information transmission system includes a first wireless input device, a first wireless transceiver, and second wireless transceiver. The first wireless input device is used for issuing a first input information. The first wireless transceiver is mounted on a first host, and previously set to have a first receiving channel, a receiving/transmitting channel, a first receiving identifier, and a receiving/transmitting identifier. The first input information is received by the first wireless transceiver in every first time interval according to the first receiving channel and the first receiving identifier, and inputted into the first host. The second wireless transceiver is mounted on a second host, and previously set to have the receiving/transmitting channel and the receiving/transmitting identifier. Moreover, a first transmission information issued from the first wireless transceiver in every second interval is received by the second wireless transceiver according to the receiving/transmitting channel and the receiving/transmitting identifier, and a second transmission information is issued from the second wireless transceiver in every third time interval. The second transmission information is received by the first wireless transceiver in every third time interval according to the receiving/transmitting channel and the receiving/transmitting identifier.

In an embodiment, the second wireless transceiver is further previously set to have a second receiving channel and a second receiving identifier.

In an embodiment, the wireless radio frequency information transmission system further includes a second wireless input device for issuing a second input information. The second input information is received by the second wireless transceiver in every first time interval according to the second receiving channel and the second receiving identifier, and inputted into the second host.

In an embodiment, the first wireless input device and the second wireless input device are cursor control devices, and the first input information and the second input information are cursor control messages.

In an embodiment, the first wireless input device and the second wireless input device are wireless keyboards.

In an embodiment, the receiving/transmitting channel and the receiving/transmitting identifier are previously set through the first host and the second host.

In an embodiment, the first time interval, the second time interval and the third time interval are consecutive time intervals.

In an embodiment, each of the first transmission information and the second transmission information is a text message, a picture message or a to-be-transmitted file.

In an embodiment, the first host and the second host are personal computers or notebook computers.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an application of a wireless radio frequency technology according to the prior art;

FIG. 2 is a schematic functional block diagram illustrating an information transmission system according to a first embodiment of the present invention;

FIG. 3 is a schematic timing waveform diagram illustrating the information transmission operations of the information transmission system according to the first embodiment of the present invention;

FIG. 4 is a flowchart illustrating an information transmission process performed by the application program of the first host in the information transmission system according to the first embodiment of the present invention;

FIG. 5A and 5B is a flowchart illustrating an information transmission process performed by the firmware component of the first wireless transceiver in the information transmission system according to the first embodiment of the present invention;

FIG. 6 schematically illustrates the architecture of an information transmission system according to a second embodiment of the present invention;

FIG. 7 is a schematic functional block diagram illustrating the information transmission system according to the second embodiment of the present invention; and

FIG. 8 is a schematic timing waveform diagram illustrating the information transmission operations of the information transmission system according to the second embodiment of the present invention.

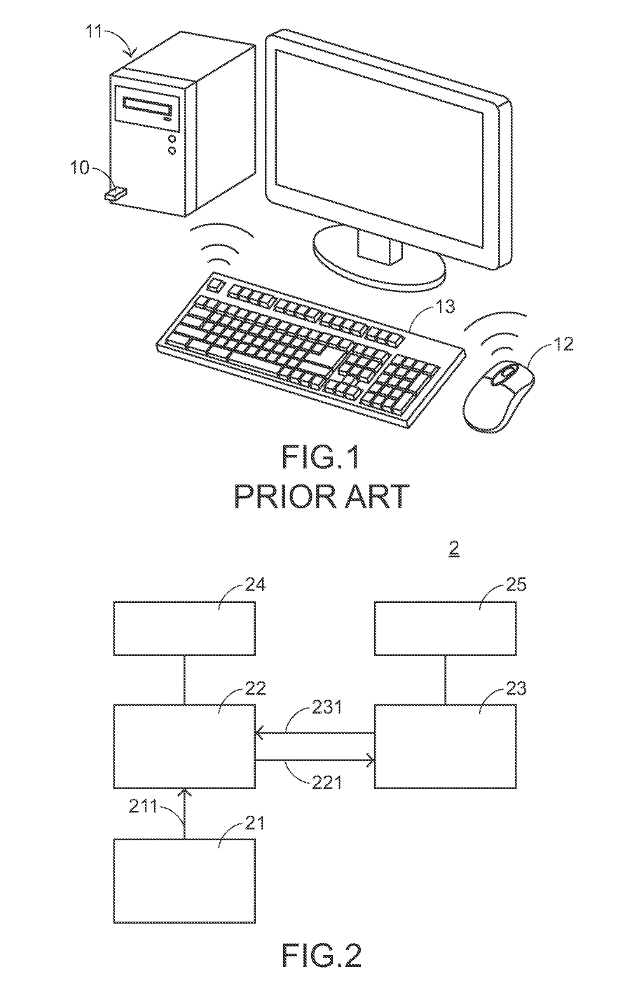

### DETAILED DESCRIPTION OF THE PREFERRED EMBODIMENT

FIG. 2 is a schematic functional block diagram illustrating an information transmission system according to a first embodiment of the present invention. As shown in FIG. 2, the information transmission system 2 comprises a first wireless input device 21, a first wireless transceiver 22 and a second wireless transceiver 23. The first wireless input device 21 is mounted on a first host 24. The second wireless transceiver 23 is mounted on a second host 25. Moreover, respective application programs for transmitting information are installed in the first host 24 and the second host 25. The first wireless input device 21 is operated by a user to issue a first input information 211 in a first receiving channel through an antenna (not shown). In an embodiment, the first wireless input device 21 is a cursor control device, and the first input information 211 is cursor control information. In other embodiments, the first wireless input device 21 is a wireless keyboard or any other wireless input device.

Moreover, the first wireless transceiver 22 is previously set to have a first receiving channel, a receiving/transmitting channel, a first receiving identifier, and a receiving/transmitting identifier. The second wireless transceiver 23 is previously set to have the receiving/transmitting channel and the receiving/transmitting identifier. Under execution of the application programs installed in the first host 24 and the second host 25, the receiving/transmitting channel and the receiving/transmitting identifier may be previously set by the user. Moreover, the receiving/transmitting channel and the receiving/transmitting identifier are employed at the moment when the information is exchanged between the first host 24 and the second host 25. In an embodiment, the first host 24 and the second host 25 are personal computers or notebook computers.

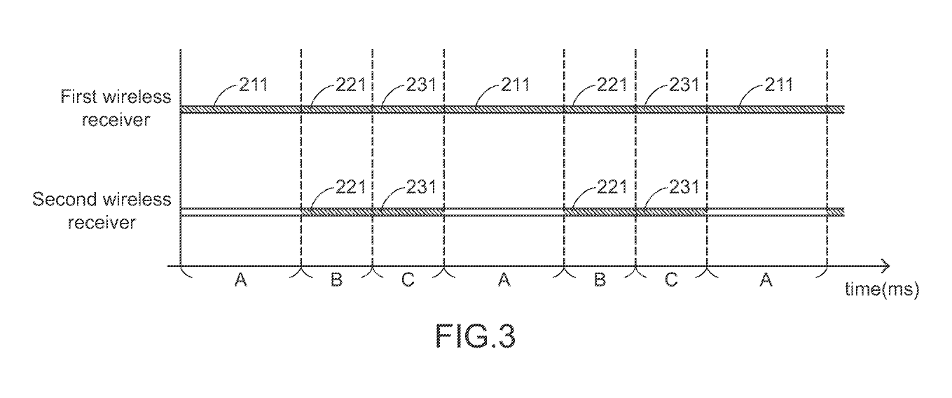

FIG. 3 is a schematic timing waveform diagram illustrating the information transmission operations of the information transmission system according to the first embodiment of the present invention. The transverse axis denotes time in the unit of millisecond (ms). Please refer to FIG. 3. The first input information 211 is received by the first wireless transceiver 22 in every first time interval A according to the first receiving channel and the first receiving identifier, and inputted into the first host 24. After the first input information 211 is inputted into the first host 24, the first host 24 may be controlled by the user.

The process of exchanging transmission information between the two hosts indicates the process of transmitting the first transmission information 221 from the first host 24 to the second host 25 or transmitting the second transmission information 231 from the second host 25 to the first host 24. For exchanging transmission information between the two hosts, the first transmission information 221 and the second transmission information 231 are inputted into respective application programs of the first host 24 and the second host 25 by a user. Through a corresponding antenna (not shown), the first transmission information 221 is issued from the first wireless transceiver 22 in every second time interval B. Moreover, in every second time interval B, the first transmission information 221 is received by the second wireless transceiver 23 according to the receiving/transmitting channel and the receiving/transmitting identifier, and inputted into the second host 25. Then, through a corresponding antenna (not shown), the second transmission information 231 is issued from the second wireless transceiver 23 in every third time interval C. Moreover, in the third time interval C, the second transmission information 231 is received by the first wireless transceiver 22 according to the receiving/transmitting channel and the receiving/transmitting identifier, and inputted into the first host 24. In this embodiment, each of the first transmission information 221 and the second transmission information 231 is a text message, a picture message or a to-be-transmitted file. By the information transmission system, the user may easily transmit texts, pictures or files from the first host 24 to the second host 25.

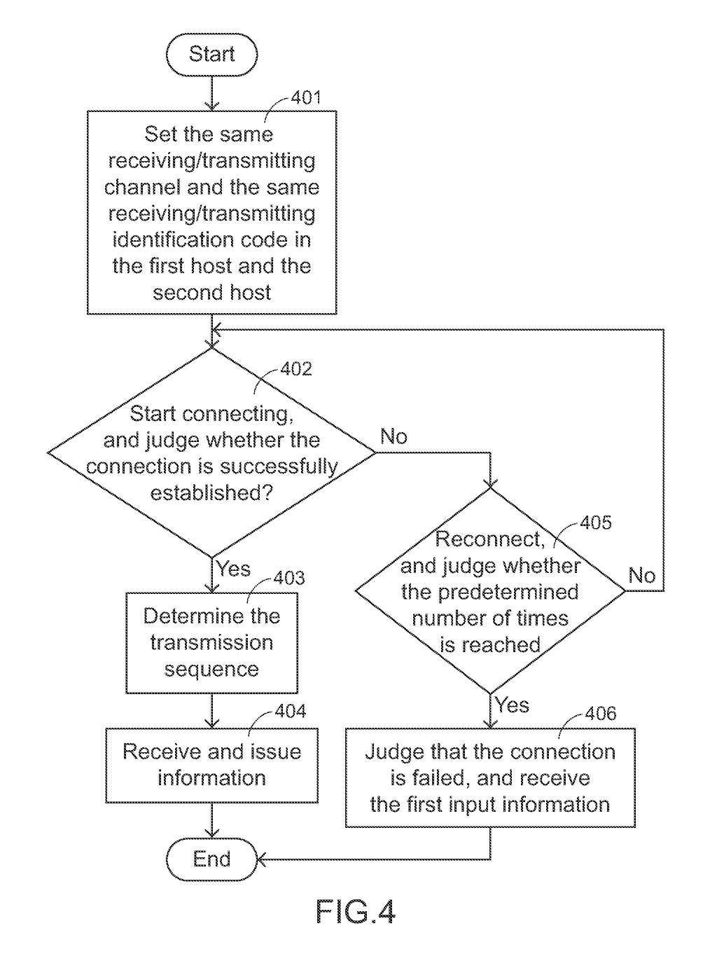

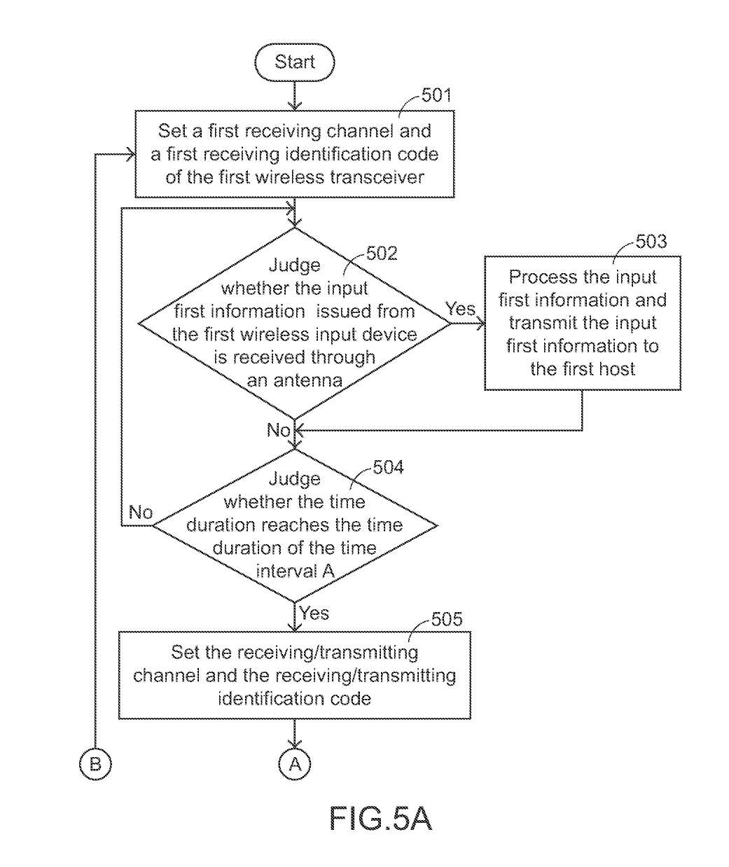

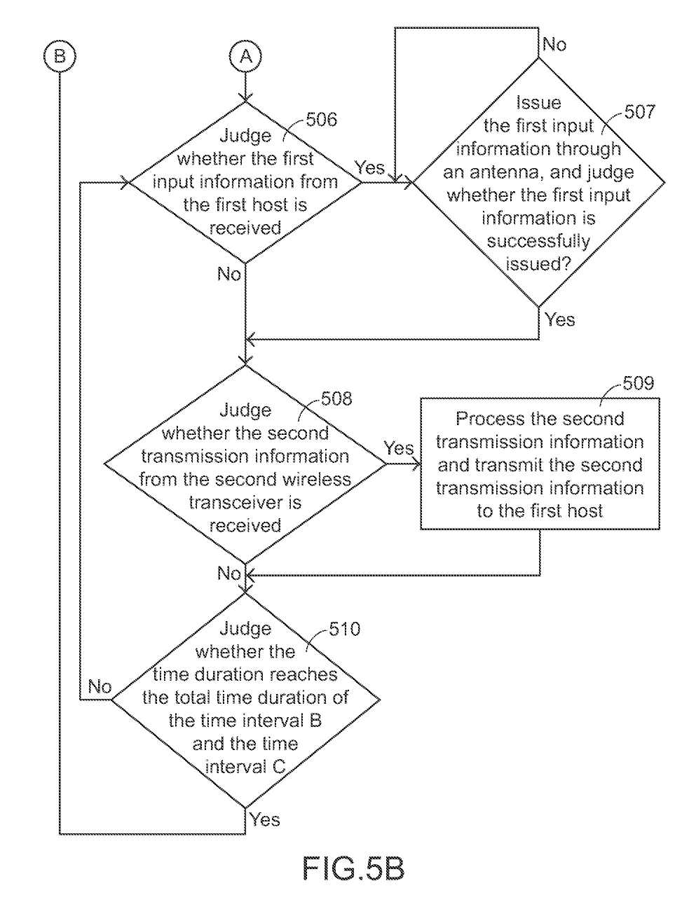

Please refer to FIG. 3 again. The first time interval A, the second time interval B and the third time interval C are consecutive time intervals. The sequencing is not limited to the sequence of FIG. 3. However, the sequencing of the first time interval A, the second time interval B and the third time interval C may be adjusted according to the settings of the system. The above approaches of receiving information according to the receiving/transmitting channel and the receiving/transmitting identifier are applied to a wireless radio frequency technology. This wireless radio frequency technology is known in the prior art, and is not redundantly described herein. Whereas, according to the information transmission system of the present invention, the method of exchanging information between two hosts are implemented by the application programs and firmware components, which are respectively installed in the hosts and the wireless transceivers. Hereinafter, the method of exchanging information will be illustrated with reference to FIGS. 4 and 5.

FIG. 4 is a flowchart illustrating an information transmission process performed by the application program of the first host in the information transmission system according to the first embodiment of the present invention. For using the information transmission system of the present invention, respective application programs should be firstly installed in the first host 24 and the second host 25 for transmitting information. After the application programs are installed, the application programs are executed to set the same receiving/transmitting channel and the same receiving/transmitting identifier in the first host 24 and the second host 25 (Step 401). After the receiving/transmitting channel and the receiving/transmitting identifier are introduced into the firmware components that are installed in the wireless transceivers, the step 402 is performed to start connecting the first wireless transceiver 22 and the second wireless transceiver 23 and judge whether the connection is successfully established. That is, the step 402 is performed to judge the connection statuses of the first wireless transceiver 22 and the second wireless transceiver 23. If the connection is successfully established, the step 403 is performed to determine the transmission sequence to designate one of the first wireless transceiver 22 and the second wireless transceiver 23 to issue information earlier and the other of the two wireless transceivers receive information earlier. After the transmission sequence is determined, the process of receiving and issuing information will be performed (Step 404). Meanwhile, the information to be transmitted may be inputted by user and issued through the application programs. On the other hand, if the connection is not successfully established in the step 402, the step 405 is performed to reconnect for a predetermined number of times and judge whether the predetermined number of times is reached. If the predetermined number of times has not been reached, the step 402 is repeated done to connect again. However, if the predetermined number of times is reached, the connection is failed. Meanwhile, the first wireless transceiver 22 is only permitted to receive the first input information 211 (Step 406). In other words, if the connection is failed, the function of the first wireless transceiver 22 is similar to that of the conventional receiver.

Moreover, in the information transmission system of the present invention, the first wireless transceiver 22 and the second wireless transceiver 23 have firmware components cooperating with the application programs. FIG. 5A and 5B is a flowchart illustrating an information transmission process performed by the firmware component of the first wireless transceiver in the information transmission system according to the first embodiment of the present invention. Please refer to FIGS. 3, FIGS. 5A and 5B. Firstly, a first receiving channel and a first receiving identifier of the first wireless input device 21 are set (Step 501). Then, the step 502 is performed to judge whether the input first information 221 issued from the first wireless input device 21 is received according to the first receiving channel and the first receiving identifier through a corresponding antenna. If the judging condition of the step 502 is satisfied, the input first information 221 is processed and transmitted to the first host 24 (Step 503). If the judging condition of the step 502 is not satisfied, the step 504 is performed to judge whether the time duration reaches the time duration of the time interval A. If the judging condition of the step 504 is not satisfied, the step 502 is repeatedly done to continuously judge whether the input first information 221 issued from the first wireless input device 21 is received by the wireless transceiver. Whereas, if the time duration reaches the time duration of the time interval A in the step 504, the information transmission system enters an information transmission mode.

The information transmission mode includes an information issuing mode and an information receiving mode. Firstly, the first wireless transceiver 22 enters the information issuing mode. Then, the step 505 is performed to set the receiving/transmitting channel and the receiving/transmitting identifier. That is, the receiving/transmitting channel and the receiving/transmitting identifier previously set through the application program are introduced into the first host 24. In such way, the first wireless transceiver 22 is able to issue the first input information 221 and receive the second input information in the receiving/transmitting channel and the receiving/transmitting identifier. Then, the step 506 is performed to judge whether the first input information 221 from the first host 24 is received. If the step 506 is satisfied, the step 507 is performed to issue the first input information 221 through a corresponding antenna and judge whether the first input information 221 is successfully issued. If the first input information 221 is not successfully issued, the step 507 is repeatedly done to issue the first input information 221 and judge whether the first input information 221 is successfully issued. Whereas, if the first input information 221 to be issued is received by the first host 24 or the first input information 221 is successfully issued, the first wireless transceiver 22 enters the information receiving mode.

In the information receiving mode, since the receiving/transmitting channel and the receiving/transmitting identifier have been set, the step 508 is performed to judge whether the second transmission information 231 from the second wireless transceiver 23 is received. If the judging condition of the step 508 is satisfied, the step 509 is performed to process the second transmission information 231 and transmit the second transmission information 231 to the first host 24. Whereas, if the judging condition of the step 508 is not satisfied, the step 510 is performed to judge whether the time duration reaches the total time duration of the time interval B and the time interval C. If the judging condition of the step 510 is not satisfied, the step 506 is repeatedly done to judge whether the first input information 221 from the first host 24 is received. Whereas, if the judging condition of the step 510 is satisfied, the step 501 is repeatedly done to set the first receiving channel and the first receiving identifier of the first wireless input device 21 so as to receive the first input information 221 from the first wireless input device 21. The above steps are repeatedly done in the firmware of the wireless transceiver.

Moreover, during the process of transmitting information, the sequence of entering the information issuing mode and the information receiving mode of the first wireless transceiver 22 may be set through the application program of the computer host. The sequence of entering the information issuing mode and the information receiving mode does not adversely affect the function of the information transmission system. However, if the first wireless transceiver 22 is set to enter the information issuing mode earlier, the second wireless transceiver 23 is set to enter the information receiving mode earlier. In such way, the information can be effectively transmitted. In a case that the first wireless transceiver 22 and the second wireless transceiver 23 enter the information transmission mode, regardless of whether the information issuing mode or the information receiving mode is earlier, the receiving/transmitting channel and the receiving/transmitting identifier should be previously set.

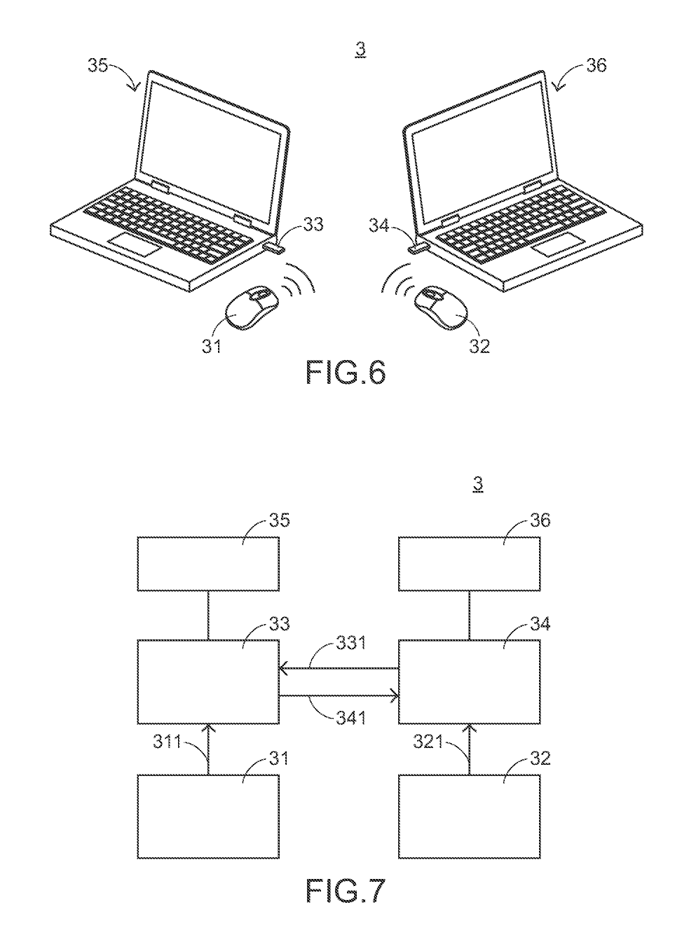

FIG. 6 schematically illustrates the architecture of an information transmission system according to a second embodiment of the present invention. FIG. 7 is a schematic functional block diagram illustrating the information transmission system according to the second embodiment of the present invention. As shown in FIGS. 6 and 7, the information transmission system 3 comprises a first wireless input device 31, a second wireless input device 32, a first wireless transceiver 33 and a second wireless transceiver 34. The first wireless transceiver 33 is mounted on a first host 35. The second wireless transceiver 34 is mounted on a second host 36. Moreover, respective application programs for transmitting information are installed in the first host 35 and the second host 36.

In this embodiment, the first wireless input device 31 and the second wireless input device 32 are respectively operated by two users. The first wireless input device 31 is used to issue a first input information 311 in a first receiving channel through a corresponding antenna (not shown). The second wireless input device 32 is used to issue second input information 321 in a second receiving channel through a corresponding antenna (not shown). Moreover, the first wireless transceiver 33 is previously set to have a first receiving channel, a receiving/transmitting channel, a first receiving identifier, and a receiving/transmitting identifier. The second wireless transceiver 34 is previously set to have a second receiving channel, a second receiving identifier, the receiving/transmitting channel and the receiving/transmitting identifier. Under execution of the application programs installed in the first host 35 and the second host 36, the receiving/transmitting channel and the receiving/transmitting identifier of the first wireless transceiver 33 and the second wireless transceiver 34 may be previously set by the two users. Moreover, the receiving/transmitting channel and the receiving/transmitting identifier are employed at the moment when the information is exchanged between the first host 35 and the second host 36.

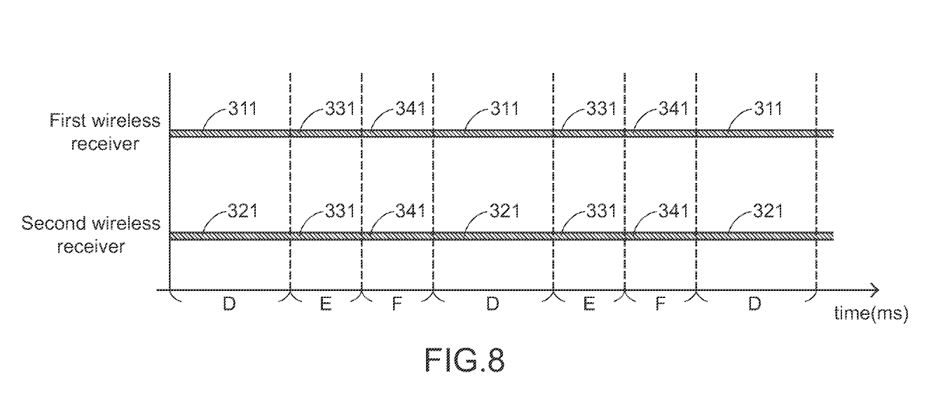

FIG. 8 is a schematic timing waveform diagram illustrating the information transmission operations of the information transmission system according to the second embodiment of the present invention. Please refer to FIG. 8. The first input information 311 is received by the first wireless transceiver 33 in every first time interval D according to the first receiving channel and the first receiving identifier, and inputted into the first host 35. After the first input information 311 is inputted into the first host 35, the first host 35 may be controlled by a first user. Moreover, a second input information 321 is received by the second wireless transceiver 34 in every first time interval D according to the second receiving channel and the second receiving identifier, and inputted into the second host 36. After the second input information 321 is inputted into the second host 36, the second host 36 may be controlled by a second user.

For transmitting the first transmission information 331 from the first host 35 to the second host 36 or transmitting the second transmission information 341 from the second host 36 to the first host 35, the first transmission information 331 and the second transmission information 341 are inputted into respective application programs of the first host 35 and the second host 36 by the two users. Through a corresponding antenna (not shown), the first transmission information 331 is issued from the first wireless transceiver 33 in every second time interval E. Moreover, in every second time interval E, the first transmission information 331 is received by the second wireless transceiver 34 according to the receiving/transmitting channel and the receiving/transmitting identifier, and inputted into the second host 36. Then, through a corresponding antenna (not shown), the second transmission information 341 is issued from the second wireless transceiver 34 in every third time interval F. Moreover, in the third time interval F, the second transmission information 341 is received by the first wireless transceiver 31 according to the receiving/transmitting channel and the receiving/transmitting identifier, and inputted into the first host 35. In this embodiment, each of the first transmission information 331 and the second transmission information 341 is a text message, a picture message or a to-be-transmitted file. Consequently, by the information transmission system of the present invention, the functions of chatting or sharing pictures and files will be achieved.

Like the above embodiment, respective application programs for transmitting information are installed in the first host 35 and the second host 36 of the information transmission system of this embodiment. Similarly, respective firmware components for transmitting information are installed in the first wireless transceiver 33 and the second wireless transceiver 34. The information transmission process performed by the firmware component of the wireless transceiver is similar to that of the above embodiment, and is not redundantly described herein.

From the above description, the information transmission system of the present invention can improve the architecture of the wireless receiver and the computer peripheral input device and fully utilize the redundant hardware resources. Consequently, the text files and picture files can effectively transmitted between two hosts.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless radio frequency information transmission system, comprising:
a first wireless input device for issuing a first input information;
a first wireless transceiver mounted on a first host, and previously set to have a first receiving channel, a receiving/transmitting channel, a first receiving identifier, and a receiving/transmitting identifier, wherein said first input information is received by said first wireless transceiver in every first time interval according to said first receiving channel and said first receiving identifier, and inputted into said first host; and
a second wireless transceiver mounted on a second host, and previously set to have said receiving/transmitting channel and said receiving/transmitting identifier, wherein a first transmission information issued from said first wireless transceiver in every second interval is received by said second wireless transceiver according to said receiving/transmitting channel and said receiving/transmitting identifier, and a second transmission information is issued from said second wireless transceiver in every third time interval, wherein said second transmission information is received by said first wireless transceiver in every third time interval according to said receiving/transmitting channel and said receiving/transmitting identifier.

2. The wireless radio frequency information transmission system according to claim 1, wherein said second wireless transceiver is further previously set to have a second receiving channel and a second receiving identifier.

3. The wireless radio frequency information transmission system according to claim 2, further comprising a second wireless input device for issuing a second input information, wherein said second input information is received by said second wireless transceiver in every first time interval according to said second receiving channel and said second receiving identifier, and inputted into said second host.

4. The wireless radio frequency information transmission system according to claim 3, wherein said first wireless input device and said second wireless input device are cursor control devices, and said first input information and said second input information are cursor control messages.

5. The wireless radio frequency information transmission system according to claim 3, wherein said first wireless input device and said second wireless input device are wireless keyboards.

6. The wireless radio frequency information transmission system according to claim 1, wherein said receiving/transmitting channel and said receiving/transmitting identifier are previously set through said first host and said second host.

7. The wireless radio frequency information transmission system according to claim 1, wherein said first time interval, said second time interval and said third time interval are consecutive time intervals.

8. The wireless radio frequency information transmission system according to claim 1, wherein each of said first transmission information and said second transmission information is a text message, a picture message or a to-be-transmitted file.

9. The wireless radio frequency information transmission system according to claim 1, wherein said first host and said second host are personal computers or notebook computers.
